(19) United States
(12) Patent Application Publication
(10) Pub. No.: US 2025/0283588 A1
(43) Pub. Date: Sep. 11, 2025

(54) LED LAMP STRIP BUCKLE

(71) Applicant: GAATU INC, TRACY, CA (US)

(72) Inventor: YUBIN PU, TRACY, CA (US)

(21) Appl. No.: 18/599,780

(22) Filed: Mar. 8, 2024

(51) Int. Cl. F21V 19/00; F21Y 103/10; F21Y 115/10

(52) U.S. Cl. CPC F21V 19/004; F21V 21/088; F21Y 2103/10; F21Y 2115/10

(57) ABSTRACT

A LED lamp strip buckle relating the field of buckles is provided, including a buckle body. The buckle body comes with a first buckling slot and a second buckling slot respectively arranged on two sides of the buckle body. The buckle body is firmly connected with a LED lamp strip through an engagement cooperation between the first buckling slot (11) and the LED lamp strip. The LED lamp strip is firmly connected with an installation structure through an engagement cooperation between the second buckling slot and the installation structure.

### FIELD OF THE DISCLOSURE

The present disclosure relates to the technical field of buckles, and specifically to a LED lamp strip buckle.

### BACKGROUND OF THE DISCLOSURE

LED light bars, also known as LED lamp strips which specifically refer to flexible lamp strips. LED lamp strips are categorized into hard lamp strips and soft lamp strips. The former involves assembling LEDs on a PCB hard board while the latter denotes assembling LEDs on strip-shaped FPCs (flexible circuit boards). LED lamp strips have gradually emerged in various decoration industries because LED lamp strips have a long service life (generally normal service life is 80,000 to 100,000 hours), and are very energy-saving and environmentally friendly.

At present, the common LED lamp strip buckles are configured to fix LED lamp strips on walls and wooden boards. When it is necessary to install LED lamp strips on racks and wardrobe racks to provide lighting for them while creating a warm atmosphere, screw connections are usually required. The operation is cumbersome with low efficiency, and is prone to causing damage to storage racks, wardrobe racks, etc.

### SUMMARY OF THE DISCLOSURE

The purpose of the present disclosure is to solve the problem that conventional LED lamp strip buckles usually require physical screw connections, often involving cumbersome operations, low construction efficiency and increased construction costs. The present disclosure provides an LED lamp strip buckle.

In order to achieve the above objects, the technical solution adopted by the present disclosure is as follows: A LED lamp strip buckle is provided, including a buckle body which comes with a first buckling slot and a second buckling slot. The first buckling slot and the second buckling slot are respectively arranged on two sides of the buckle body. The buckle body (1) is firmly connected with a LED lamp strip through an engagement cooperation between the first buckling slot (11) and the LED lamp strip. The LED lamp strip is firmly connected with the installation structure through an engagement cooperation between the second buckling slot (12) and the installation structure.

In preferred embodiments, the first buckling slot is arranged in a “ [symbol] ” shape, and the opening of the first buckling slot faces a side of the buckle body deviating from the second buckling slot.

In preferred embodiments, a length direction of the first buckling slot is perpendicular to a length direction of the second buckling slot.

In preferred embodiments, the opening direction of the first buckling slot is opposite to an opening direction of the second buckling slot.

In preferred embodiments, two protruding edges are respectively provided on two opposite inner walls of the first buckling slot, the protruding edge (111) is arranged in a length direction of the first buckling slot, and a sliding slot slidably matched with the protruding edge is provided on each of two sides of the LED lamp strip.

In preferred embodiments, both of the two protruding edges are arranged on the bottom of the opening of the first buckling slot.

In preferred embodiments, a gap at the opening of the second buckling slot is smaller than a gap inside the second buckling slot.

In preferred embodiments, a first protruding part and a second protruding part are correspondingly provided on the buckle body, the first protruding part and the second protruding part are arranged oppositely, and the second buckling slot is defined jointly by the first protruding part and the second protruding part.

In preferred embodiments, the first protruding part and the second protruding part are both hollow inside.

In preferred embodiments, the installation structure is a metal wire mesh.

After adopting the above technical solution, the beneficial effects of the present disclosure are as follows:

When the present disclosure is in use, the buckle body is firmly connected with the LED lamp strip through the engagement cooperation between the first buckling slot and the LED lamp strip, and the buckle body is firmly connected to the installation structure through the engagement cooperation between the second buckling slot and the installation structure, so that the buckle body and the installation structure are firmly with each other, thereby realizing the connection and fixation between the LED lamp strip and the installation structure. At this time, the LED lamp strip and the installation structure are installed together in the storage rack, cabinet rack and so on, thus providing lighting for the storage rack, cabinet rack and other spaces while creating a warm atmosphere. There is no need to use screws during the installation process, which practically and greatly improves construction efficiency and will causes no damage.

### BRIEF DESCRIPTION OF THE DRAWINGS

In order to explain the embodiments of the present disclosure or the technical solutions in the prior art more clearly, the drawings needed to be used in the description of the embodiments or the prior art will be briefly introduced below. Obviously, the drawings in the following description are only some embodiments of the present disclosure. For those possessing general skills in the art, other drawings can be obtained based on these drawings without exerting any creative effort.

FIG. 1 is a schematic diagram of an overall structure of the present disclosure; and

FIG. 2 is another perspective view of the present disclosure.

FIG. 3 is a schematic diagram showing a disassembled state of a lamp strip buckle, a LED lamp strip, and an installation structure of the present disclosure.

Reference numeral: 1, buckle body; 11, first buckling slot; 111, protruding edge; 12, second buckling slot; 121, first protruding part; 122, second protruding part; 13, communication slot; 14, LED lamp strip; 15, installation structure.

### DETAILED DESCRIPTION OF THE EXEMPLARY EMBODIMENTS

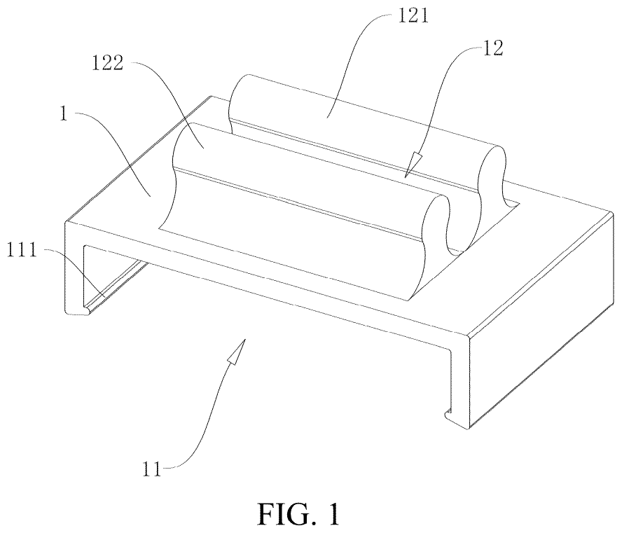

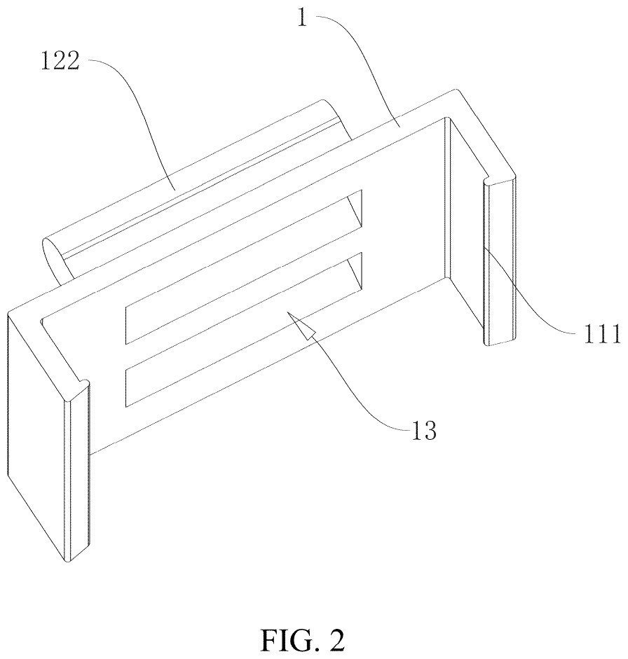

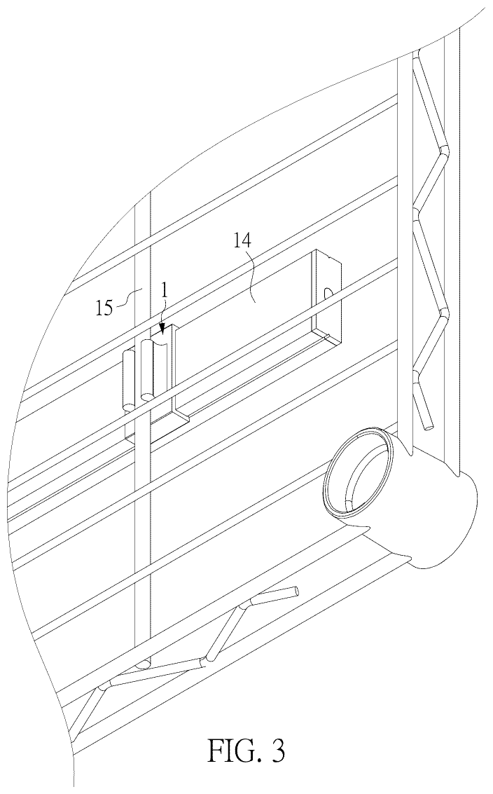

The technical solutions in the embodiments of the present disclosure will be clearly and completely described below with reference to the accompanying FIG. 1 to FIG. 3 in the embodiments of the present disclosure. Obviously, the described embodiments are only some, not all, of the embodiments of the present disclosure. Based on the embodiments of the present disclosure, all other embodiments obtained by those possessing general skills in the art without creative efforts fall within the scope of protection of the present disclosure.

It should be noted that the terms “center”, “longitudinal”, “horizontal”, “upper”, “lower”, “front”, “back”, “left”, “right”, “top”, “bottom”, “inner”, “outer”, “back”, “side”, “circumferential”, etc. indicating orientations or positional relationships based on those shown in the drawings, and are only for the convenience of describing the present disclosure and simplifying the descriptions; they carry no explicit or implicit indications that the device or an element referred to must have a specific orientation, and be constructed and operated in a specific orientation. Therefore, it cannot be construed as a limitation of the present disclosure. In addition, words such as first and second are only used to distinguish multiple components or structures with the same or similar structure, and do not indicate any special limitation on the arrangement order or connection relationship.

The present embodiment relates to a lamp strip buckle. Referring to FIGS. 1 to 3, the lamp strip buckle includes a buckle body 1. The buckle body 1 comes with a first buckling slot 11 and a second buckling slot 12. The first buckling slot 11 and the second buckling slot 12 are respectively arranged on an upper side and a lower side of the buckle body 1. The buckle body 1 is firmly connected with a LED lamp strip 14 through an engagement cooperation between the first buckling slot 11 and the LED lamp strip 14. The LED lamp strip 14 is firmly connected with the installation structure 15 in a practical application through an engagement cooperation between the second buckling slot 12 and the installation structure 15. It should be noted that in the present embodiment, the specific usage application is to provide lighting for some net racks, wardrobe racks, etc., and the installation structure 15 is a metal wire mesh, that is, the LED lamp strip 14 is fixed on the metal wire mesh through the buckle body, and then the metal wire mesh is installed on the storage rack, wardrobe rack and so on, the present disclosure can provide lighting for the storage racks, wardrobe racks and other spaces while creating a warm atmosphere.

It can be understood that during installation, the connection between the buckle body 1 and the LED lamp strip 14 is first realized through the engagement cooperation between the first buckling slot 11 and the LED lamp strip 14, and then the engagement cooperation between the second buckling slot 12 and the installation structure 15 is realized, so that the connection between the LED lamp strip 14 and the installation structure 15 is realized. The operation is simple and convenient and the use of screws is unnecessary, which practically and greatly improves the construction efficiency, thus reducing the construction cost.

Furthermore, the first buckling slot 11 is arranged in a “ [symbol] ” shape, and the opening of the first buckling slot 11 faces a side of the buckle body 1 deviating from the second buckling slot 12.

It can be understood that by arranging the first buckling slot 11 in the “ [symbol] ” shape, during installation, the buckle body 1 can be correspondingly engaged to both sides of the LED lamp strip 14 through the first buckling slot 11, so that the LED lamp strip 14 and the buckle body 1 can fit more stably.

Moreover, a length direction of the first buckling slot 11 and a length direction of the second buckling slot 12 are perpendicular to each other.

Additionally, the opening direction of the first buckling slot 11 and that of the second buckling slot 12 are arranged oppositely.

It can be understood that through the above arrangement, the LED lamp strip 14 and the installation structure 15 are respectively located on both sides of the buckle body 1, which is easy to install, and the LED lamp strip 14 is not to be blocked by the buckle body 1, thereby ensuring a decorative effect of the LED lamp strip 14.

In addition, two opposite side walls of the first buckling slot 11 are respectively provided with two protruding edges 111, the two protruding edges 111 are arranged along the length direction of the first buckling slot 11. Both protruding edges 111 are arranged on the bottom of the opening of the first buckling slot 11, and both sides of the LED lamp strip 14 are respectively provided with sliding slots for sliding fit with the protruding edges 111.

It can be understood that through the cooperation between the protruding edge 111 on the first buckling slot 11 and the sliding slot on the LED lamp strip 14, the buckle body 1 and the LED lamp strip 14 can cooperate more closely, and the buckle body 1 can slide along the length direction of the LED lamp strip 14, so that during on-site installation, the number of buckle bodies 1 on the LED lamp strip 14 and the spacing between two adjacent buckle bodies 1 can be adjusted as needed. The adjustment process is simple and convenient, which only needs to drive the buckle body 1 to slide on the LED lamp strip 14.

Further, a gap at the opening of the second buckling slot 12 is smaller than a gap inside the second buckling slot 12, so that the second buckling slot 12 can be securely connected with the installation structure 15 (e.g., the metal wire mesh or other structures), and the buckle body 1 does not easily fall off.

Further, the buckle body 1 is correspondingly provided with a first protruding part 121 and a second protruding part 122. The first protruding part 121 and the second protruding part 122 are arranged oppositely, and they are integrally formed with the buckle body 1. The second buckling slot 12 is defined jointly by the first protruding part 121 and the second protruding part 122.

It can be understood that the second buckling slot 12 defined jointly by the first protruding part 121 and the second protruding part 122 can be engaged with the installation structure 15, thereby realizing the connection and fixation between the buckle body 1 and the installation structure 15, that is, the connection and fixation between the LED lamp strip 14 and the installation structure 15 is realized, and the first protruding part 121 and the second protruding part 122 are integrally formed with the buckle body 1, which carries low production cost and makes marketing promotion easier.

Further, the first protruding part 121 and the second protruding part 122 are both hollow inside. Also, the buckle body 1 is provided with two communication slots 13 that spatially communicate with the interiors of the first protruding part 121 and the second protruding part 122 respectively.

It can be understood that by configuring the interiors of the first protruding part 121 and the second protruding part 122 to be hollow, production consumables can be further reduced, driving down production costs to an ever-lower level.

In addition, in order to prevent the first protruding part 121 and the second protruding part 122 from scratching human hands, in the present embodiment, surfaces of the first protruding part 121 and the second protruding part 122 are each arranged in a circular arc transition.

The working principle of the present disclosure is generally as follows. During installation, the buckle body 1 is connected to the LED lamp strip 14 through the engagement cooperation between the first buckling slot 11 and the LED lamp strip 14, then the second buckling slot 12 of the buckle body 1 is configured to face the installation structure 15 (e.g., the metal wire mesh), and the second buckling slot 12 of the buckle body 1 is engaged to the installation structure 15, so that the connection between the buckle body 1 and the installation structure 15 is realized, thereby realizing the connection between the LED lamp strip 14 and the installation structure 15.

The above is only used to illustrate the technical solution of the present disclosure without limiting it. Other modifications or equivalent substitutions made by those possessing general skills in the art to the technical solution of the present disclosure shall be covered by the claims of the present disclosure as long as they do not depart from the spirit and scope of the technical solution of the present disclosure.

1. A LED lamp strip buckle, comprising a buckle body (1), wherein the buckle body (1) comes with a first buckling slot (11) and a second buckling slot (12), and the first buckling slot (11) and the second buckling slot (12) are respectively arranged on two sides of the buckle body (1);
wherein the buckle body (1) is firmly connected with a LED lamp strip (14) through an engagement cooperation between the first buckling slot (11) and the LED lamp strip (14);
wherein the LED lamp strip is firmly connected with an installation structure (15) through an engagement cooperation between the second buckling slot (12) and the installation structure (15);
wherein a first protruding part (121) and a second protruding part (122) are correspondingly provided on the buckle body (1), the first protruding part (121) and the second protruding part (122) are arranged oppositely and parallel to each other, the second buckling slot (12) is defined jointly by the first protruding part (121) and the second protruding part (122), an end of each of the first protruding part (121) and the second protruding part (122) has an expansion.

2. The LED lamp strip buckle assembly according to claim 1, wherein the first buckling slot (11) is arranged in a “ [symbol] ” shape, and an opening of the first buckling slot (11) faces a side of the buckle body (1) deviating from the second buckling slot (12).

3. The LED lamp strip buckle according to claim 2, wherein a length direction of the first buckling slot (11) is perpendicular to a length direction of the second buckling slot (12).

4. The LED lamp strip buckle according to claim 1, wherein an opening direction of the first buckling slot (11) is opposite to an opening direction of the second buckling slot (12).

5. The LED lamp strip buckle according to claim 1, wherein two protruding edges (111) are respectively provided on two opposite inner walls of the first buckling slot (11), the protruding edge (111) is arranged in a length direction of the first buckling slot (11), and a sliding slot slidably matched with the protruding edge (111) is provided on each of two sides of the LED lamp strip (14).

6. The LED lamp strip buckle according to claim 5, wherein each of the two protruding edges (111) is arranged on a bottom of an opening of the first buckling slot (11).

7. The LED lamp strip buckle according to claim 1, wherein a gap at an opening of the second buckling slot (12) is smaller than a gap inside the second buckling slot (12).

8. (canceled)

9. The LED lamp strip buckle according to claim 1, wherein the first protruding part (121) and the second protruding part (122) are both hollow inside.

10. The LED lamp strip buckle according to claim 1, wherein the installation structure (15) is a metal wire mesh.
